(19) United States
(12) Patent Application Publication
(10) Pub. No.: US 2009/0180042 A1
(43) Pub. Date: Jul. 16, 2009

(54) DISPLAY APPARATUS

(75) Inventors: Takayuki Furukawa, Osaka (JP); Miyoko Irikiin, Hyogo (JP); Yukihiro Iwata, Osaka (JP); Shinya Ogasawara, Hyogo (JP); Hiroaki Takezawa, Nara (JP)

Correspondence Address: HAMRE, SCHUMANN, MUELLER & LARSON P.C., P.O. BOX 2902-0902, MINNEAPOLIS, MN, 55402, US

(73) Assignee: PANASONIC CORPORATION, Osaka (JP)

(21) Appl. No.: 12/349,189

(22) Filed: Jan. 6, 2009

(30) Foreign Application Priority Data
Jan. 10, 2008 (JP) 2008-002670

(51) Int. Cl. H04N 5/64

(52) U.S. Cl. 348/836

(57) ABSTRACT

A display apparatus including a display device, circuit boards on which circuits for driving the display device are formed, a chassis plate having a first surface to which the display device is mounted and a second surface to which the circuit boards are mounted, and a back cover fastened onto the second surface of the chassis plate by screws. The chassis plate has a first radiating rib, and the back cover has a second radiating rib that is in surface contact with the first radiating rib.

### BACKGROUND OF THE INVENTION

1. Field of the Invention

The present invention relates to a display apparatus using a display device such as a plasma display panel.

2. Related Background Art

Recently, with the reduction in thickness of display apparatuses for displaying television pictures or the like, display apparatuses using flat display devices have been replacing the conventional cathode-ray tube display. As an example, a display apparatus using a plasma display panel (hereinafter briefly referred to as a “panel”) as a display device is described below.

In such a display apparatus, the panel is mounted to one surface of a chassis plate while various circuit boards and components are mounted to the other surface of the chassis plate. Especially, semiconductor devices such as driver integrated circuits (IC) for driving the panel are also mounted. Since the driver ICs generate heat, the driver ICs are attached to a radiating plate, and the radiating plate is mounted to the chassis plate (see e.g. JP2000-338904A).

FIG. 6 is an exploded perspective view showing the structure of a conventional display apparatus 100. A space inside the display apparatus 100, which is formed by a front cover 8 and a back cover 7, accommodates a panel 2, a chassis plate 6, circuit boards such as a power circuit board 4 and panel driving circuit boards 5, radiating plates 13 to which driver ICs 9 are attached, and a tuner block 12. The panel 2 is mounted to a first surface of the chassis plate 6, with a heat conductive sheet 3 being disposed therebetween. The heat conductive sheet 3 is made of resin with high thermal conductivity. The circuit boards such as the power circuit board 4 and the panel driving circuit boards 5, and the radiating plates 13 to which the driver ICs 9 are attached are mounted to a second surface of the chassis plate 6. The radiating plates 13 are mounted to the chassis plate 6 via bosses 14 provided on the chassis plate 6.

The back cover 7 forms the back surface of the display apparatus 100. Cooling fans 11 are provided in the upper part of the back cover 7, and vent holes 10 are provided in the lower part of the back cover 7. External air is taken in through the vent holes 10 and the heated air inside the display apparatus 100 is released through the cooling fans 11, so that the whole display apparatus 100 is cooled. The back cover 7 is fixed, with screws 19, to bosses 17 provided on the chassis plate 6.

In the display apparatus 100 constituted in such a manner, the temperature of the panel 2 is increased because the driver ICs 9 with high power consumption generate a large amount of heat, and in addition, the panel 2 itself generates heat due to electric discharge. Because of a change in the electric discharge characteristics of the panel 2 caused by the high temperature of the panel 2, an erroneous discharge, such as illuminating an unselected pixel or failing to illuminate a selected pixel, is likely to occur. As a result, the quality of the image display is deteriorated.

To solve the problem, JP2000-338904A, for example, discloses a cooling structure of a plasma display apparatus. The plasma display apparatus includes a radiating plate which is connected, by leaf springs, to electronic devices mounted inside the plasma display, a back cover made of metal, and an elastic and heat conductive body disposed between the back cover and the radiating plate, and thereby heat generated in electronic devices is conducted to a back cover.

According to the above-described cooling structure, heat radiation of an electronic component having the radiating plate to which driver ICs are attached can be performed. However, in recent years, since panels have been improved rapidly to achieve large screen, high precision and high luminance, it is becoming necessary to increase further the radiation efficiency of the panel itself.

In addition, power consumption in the driver circuits including the driver ICs, which are laterally aligned in a line along the lower edge of the panel, is getting higher. Over half of the heat generated in the driver ICs is transferred to the chassis plate through the bosses, so as to be transferred from the chassis plate to the panel through the heat conductive sheet. Here, the chassis plate and the heat conductive sheet are so thin, e.g. about 1 to 4 mm, that the temperature of the panel is increased locally by the heat transferred through the bosses, thereby causing inhomogeneous distribution of the temperature in the panel.

Further, driving the fans mounted in the upper part of the back cover allows the inside of the display apparatus to be cooled by releasing the air of high temperature while taking in external air through the vent holes provided in the lower part of the back cover. However, in a section defined between the tuner block and the panel, ventilation is poor, so that the heat from the driver ICs remains. Accordingly, there has been a problem that the temperature of the panel near the driver ICs rises locally.

As described above, when the temperature of the panel rises, image display quality may be deteriorated. In addition, inhomogeneous distribution of the temperature in the panel may damage the panel. This problem is not limited to panels, but can apply to other display devices.

### SUMMARY OF THE INVENTION

It is therefore an object of the present invention to provide a display apparatus, with a relatively simple structure, which allows inhomogeneous distribution of the temperature in a display device, such as a panel, to be avoided and the temperature of the display device, such as a panel, to be kept low, while the heat of a chassis plate is conducted to a back cover.

To achieve the above described object, the display apparatus according to the present invention includes a display device, circuit boards on which circuits for driving the display device are formed, a chassis plate having a first surface to which the display device is mounted and a second surface to which the circuit boards are mounted, and a back cover covering the second surface of the chassis plate over the circuit boards, wherein the chassis plate has a first radiating rib, and the back cover has a second radiating rib that is in surface contact with the first radiating rib. Due to such a structure, it is possible to provide the display apparatus, with a relatively simple structure, which allows inhomogeneous distribution of the temperature in the display device to be avoided and the temperature of the display device to be kept low, while the heat of the chassis plate is conducted to the back cover.

The chassis plate may have a plurality of the first radiating ribs and the back cover may have a plurality of the second radiating ribs.

Further, at least one of the first radiating ribs and the corresponding second radiating rib of the display apparatus according to the present invention may be disposed at an angle relative to the vertical direction. This structure can increase the contact pressure between the surfaces of the radiating ribs, so that the heat can be conducted efficiently from the chassis plate to the back cover.

Furthermore, the back cover of the display apparatus according to the present invention is fastened onto the chassis plate by the screws. At least one of the first radiating ribs and the corresponding second radiating rib may be disposed at an angle relative to the fastening direction of the screw. This structure also can increase contact pressure between the surfaces of the radiating ribs, so that the heat can be conducted efficiently from the chassis plate to the back cover.

Moreover, it is preferable that at least one of the contact surfaces between the first radiating ribs and the second radiating ribs of the display apparatus according to the present invention has an angle relative to the vertical direction. This structure can increase the contact pressure between the surfaces of the radiating ribs, so that the heat can be conducted efficiently from the chassis plate to the back cover.

In addition, it is preferable that the back cover of the present invention is fastened onto the chassis plate by the screws. At least one of the contact surfaces between the first radiating ribs and the second radiating ribs has an angle relative to the fastening direction of the screw. This structure can increase contact pressure between the surfaces of the radiating ribs, so that the heat can be conducted efficiently from the chassis plate to the back cover.

According to the present invention, it is possible to provide the display apparatus, with a relatively simple structure, which allows inhomogeneous distribution of the temperature in a panel to be avoided and the temperature of the panel to be kept low, while the heat of the chassis plate is conducted to the back cover.

### BRIEF DESCRIPTION OF THE DRAWINGS

FIG. 1 is an exploded perspective view schematically illustrating the structure of a display apparatus in accordance with a first embodiment of the present invention;

FIG. 2 is a view illustrating first radiating ribs and second radiating ribs of the display apparatus in detail;

FIG. 3 is a view illustrating another arrangement of the radiating ribs of the display apparatus in detail;

FIG. 4 is a view illustrating further another arrangement of the radiating ribs of the display apparatus in detail;

FIG. 5 is a cross sectional view illustrating a display apparatus in accordance with a second embodiment of the present invention; and

FIG. 6 is an exploded perspective view illustrating the structure of a conventional display apparatus.

### DETAILED DESCRIPTION OF THE INVENTION

Hereinafter, a display apparatus according to embodiments of the present invention is described below with reference to the drawings.

### First Embodiment

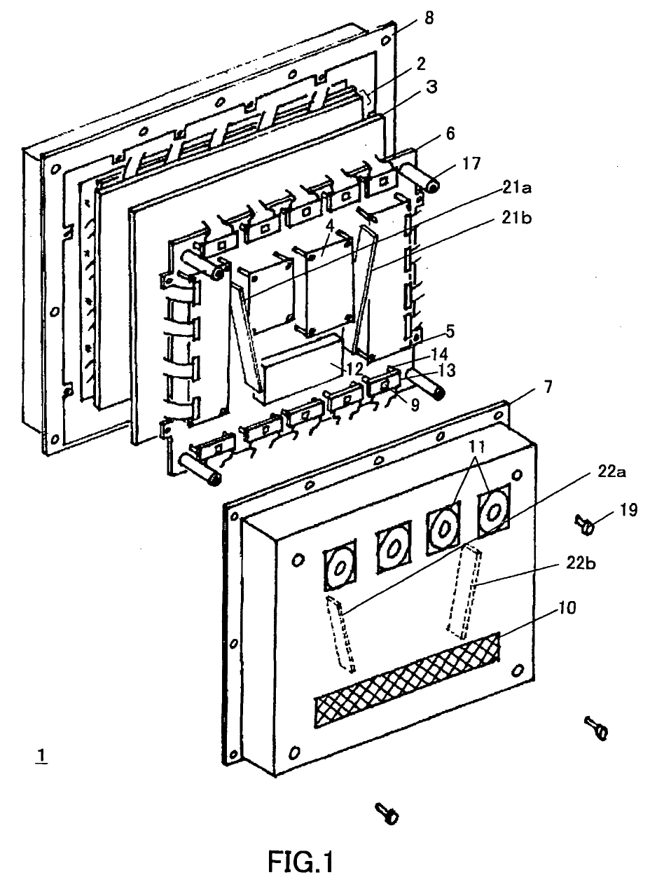

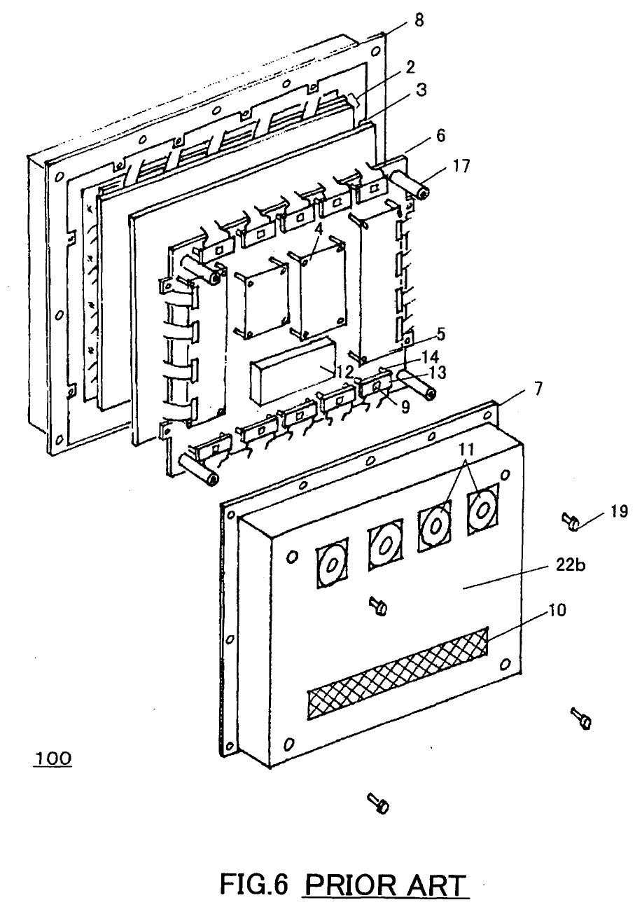

FIG. 1 is an exploded perspective view schematically illustrating the structure of a display apparatus in accordance with the first embodiment of the present invention. The components that are identical to those of the conventional display apparatus are indicated with the same numerals as in FIG. 6.

A space inside the display apparatus 100, which is formed by a front cover 8 and a back cover 7, accommodates a panel 2, a heat conductive sheet 3, a chassis plate 6, circuit boards such as a power circuit board 4 and panel driving circuit boards 5, radiating plates 13 to which driver ICs 9 are attached, and a tuner block 12.

The panel 2 is formed with a front glass substrate and a rear glass substrate, which are bonded to each other. A plurality of display electrode pairs of horizontally rectangular shape are formed on the front glass substrate. A plurality of data electrodes of vertically rectangular shape, which are coated with red, blue and green phosphors, are formed on the rear glass substrate. A discharge cell is formed at each intersection of display electrode pairs with data electrodes. The respective thicknesses of the front glass substrate and the rear glass substrate are approximately 1.5 mm to 3 mm. A voltage is applied to display electrode pairs and data electrodes to cause electric discharge in the discharge cells, and thereby the phosphors are excited by the afore-generated ultraviolet radiation to emit light. As a result, images are displayed. The panel 2 is an example of the display device.

As described above, since electric discharge is generated inside the panel 2 for displaying images, the temperature of the panel 2 tends to be high. In fact, while power consumption of the whole display apparatus 1 is 300 W to 500 W, that of panel display 2 is around 200 W to 300 W, which means power consumption of the panel 2 accounts for approximately half or more of the whole power consumption. Therefore, it is important to release the heat generated in the panel 2 effectively and to keep the temperature of the panel 2 low, e.g. 70 degree C. to 80 degree C.

The panel 2 is mounted to the chassis plate 6 via the heat conductive sheet 3, which is made of resin with high heat conductivity. The heat conductive sheet 3 is the same in shape as the panel 2, and is around 1 mm to 4 mm in thickness. The mediation of the heat conductive sheet 3 allows the panel 2, mainly constituted of glass plates, and the chassis plate 6, constituted of metal plate, to be coherently bonded with each other so that the heat generated in the panel 2 effectively is released into the chassis plate 6. Further, the conductive sheet 3 absorbs not only warpages of the panel 2 and the chassis plate 6 but also external shock. For such a reason, silicon or the like having both flexibility and conductivity is used as a material of the heat conductive sheet 3.

The chassis plate 6 is approximately the same size as the panel 2 and is constituted of a metal plate, which is around 1.5 mm to 4 mm in thickness, made of aluminum or the like with high conductivity. Furthermore, for reinforcement, a bending process may be performed, or a reinforcing rib may be provided in the chassis plate 6, as needed. The panel 2 is mounted to a first surface of the chassis plate 6 via the heat conductive sheet 3. The power circuit board 4 and the panel driving circuit boards 5 are mounted to a second surface of the chassis board 6 in parallel to the panel 2. The power circuit board 4 provides power to respective circuit boards. On the panel driving circuit boards 5, there are formed the driving circuits or the like for driving respective electrodes of the panel 2, based on image signals.

In addition, the radiating plates 13 are mounted to the chassis plate 6 at a position corresponding to the lower edge of the panel 2, via the bosses 14 provided on the chassis plate 6. A plurality of the driver ICs 9 are attached to the radiating plates 13. Furthermore, a tuner block 12 is mounted to the chassis plate 6 so as to cover part of the plurality of the driver ICs 9 which are attached to the radiating plates 13.

The back cover 7 is constituted of a metal plate such as a steel plate, which is 0.5 mm to 2 mm in thickness. The back cover 7 is provided to cover the second surface of the chassis plate 6 over the circuit boards 4, 5 and the like, so as to form the rear surface of the display apparatus 1. In the upper part of the back cover 7, the cooling fans 11 are provided, while the vent holes 10 are provided in the lower part thereof.

The vent holes 10 are circular openings being 3 mm to 5 mm in diameter. The vent holes 10 are arranged over almost the entire lateral direction in the lower part of back cover 7, with a central clearance of 6 mm to 8 mm. Moreover, the opening ratio, defined as the ratio of the total opening area to the area of the whole region with the vent holes 10, is around 30% to 60%. A plurality of the fans 11 are provided in the upper part of the back cover 7. The outlet openings of the fans 11 include the same vent holes as the vent holes 10 provided in the lower part of the back cover 7. External air taken in through the vent holes 10 flows through the interspace between the back cover 7 and the chassis plate 6. The heated air inside the display apparatus 1 is discharged from the fans 11 in the upper part of the back cover 7. Accordingly, the whole display apparatus 1 is cooled. In this regard, the fans 11 may be mounted to the chassis plate 6.

The display apparatus 1 according to the first embodiment is different from conventional display apparatuses in that two first radiating ribs 21a and 21b are provided on the chassis plate 6, and two second radiating ribs 22a and 22b are provided on the back cover 7 so as to be respectively in contact with the first radiating ribs 21a and 21b.

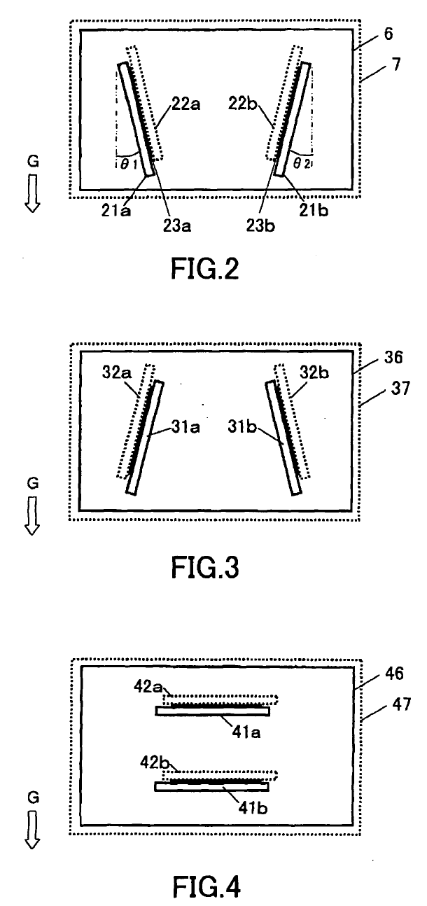

FIG. 2 is a view illustrating the detail of the first radiating ribs 21a and 21b, and the second radiating ribs 22a and 22b of the display apparatus 1 in accordance with the first embodiment of the present invention. The chassis plate 6 and the first radiating ribs 21a and 21b are indicated by solid line, while the back cover 7 and the second radiating ribs 22a and 22b are indicated by dashed line, respectively. Hereinafter, the first radiating rib or the second radiating rib also simply is referred to as “radiating rib”. The radiating ribs 21a and 21b are provided at a position where the temperature of the chassis plate 6 rises locally like a point that is covered by circuit boards. Pairs of the radiating ribs 21a and 22a, and 21b and 22b are respectively disposed at an angle relative to the vertical direction G. The angles are respectively referred to as θ1 and θ2. In other words, the pairs of the radiating ribs 21a and 22a, and 21b and 22b extend in a different direction from the vertical direction G, with a posture at right angles relative to the second surface of the chassis plate 6. Further, the radiating ribs 22a and 22b respectively are located above and in surface contact with the radiating ribs 21a and 21b, in mounting the back cover 7.

In order to mount the back cover 7 including such radiating ribs 22a and 22b to the chassis plate 6, heat conductive sheets 23a and 23b are placed respectively on the radiating ribs 21a and 21b of the chassis plate 6. In this state, the back cover 7 is mounted temporarily so that the heat conductive sheets 23a and 23b are pressed from above by the radiating ribs 22a and 22b. After that, the back cover 7 is fixed, with the screws 19, to the bosses 17 provided on the chassis plate 6. As a result, the back cover 7 is fastened onto the chassis plate 6 with the screws 19.

Such mounting allows the radiating ribs 21a and 21b provided on the chassis plate 6 to receive the weight of the back cover 7 via the radiating ribs 22a and 22b. As a result, the contact pressure between these surfaces is increased, so that the heat can be conducted efficiently from the chassis plate 6 to the back cover 7. As described above, in the first embodiment of the present invention, it is possible to avoid generation of inhomogeneous distribution of the temperature in the panel 2 and to keep the temperature of the panel 2 low, while conducting the heat of the chassis plate 6 to the back cover 7, with a relatively simple structure.

In the first embodiment shown in FIG. 2, although the radiating ribs 21a and 21b, and the radiating ribs 22a and 22b are provided so that the respective distances between the radiating ribs 21a and 21b, and the radiating ribs 22a and 22b are narrowing as going downward from the upper side to the lower side in the vertical direction G, it is not limited to such an arrangement. FIG. 3 is a view illustrating in detail another arrangement of radiating ribs 31a and 31b, and 32a and 32b in the display apparatus 1 in accordance with the first embodiment of the present invention.

The radiating ribs 31a and 31b of a chassis plate 36, and the radiating ribs 32a and 32b of a back cover 37 are provided so that the respective distances between the radiating ribs 31a and 31b, and the radiating ribs 32a and 32b are widening as going downward from the upper side to the lower side in the vertical direction G. The radiating ribs 32a and 32b of the back cover 37 respectively are located above and in surface contact with the radiating ribs 31a and 31b, in mounting the back cover 37. Even in such a configuration of the radiating ribs 31a and 31b, and 32a and 32b, the radiating ribs 31a and 31b provided on the chassis plate 36 can receive the weight of the back cover 37 via the radiating ribs 32a and 32b so that the contact pressure between these surfaces is increased. As a result, the heat can be conducted efficiently from the chassis plate 36 to the back cover 37.

FIG. 4 is a view illustrating in detail further another arrangement of radiating ribs 41a and 41b, and 42a and 42b in the display apparatus 1 in accordance with the first embodiment of the present invention.

The radiating ribs 41a and 41b of a chassis plate 46 are disposed at almost right angles relative to the vertical direction G. The radiating ribs 42a and 42b of a back cover 47 are respectively located above and in surface contact with the radiating ribs 41a and 41b, in mounting the back cover 47. Even in such a configuration of the radiating ribs 41a and 41b, and 42a and 42b, the radiating ribs 41a and 41b provided on the chassis plate 46 can receive the weight of the back cover 47 via the radiating ribs 42a and 42b so that the contact pressure between these surfaces is increased. As a result, the heat can be conducted efficiently from the chassis plate 46 to the back cover 47.

As described above, since at least one of the contact surfaces between the first radiating rib disposed on the chassis plate and the corresponding second radiating rib disposed on the back cover has an angle relative to the vertical direction, the contact pressure between the surfaces of the radiating ribs is increased. As a result, the heat can be conducted efficiently from the chassis plate to the back cover. To implement this, the first radiating rib and the second radiating rib may be, for example, a trapezoidal shape in back view, instead of being a linearly extending shape.

Further, vent holes may be provided in the radiating ribs 41a and 41b, and 42a and 42b, as needed. Providing such vent holes allows air to flow smoothly, thereby increasing the heat radiating efficiency.

Further, in the first embodiment, although both pairs of the first radiating rib and the second radiating rib are disposed at an angle relative to the vertical direction G, it is not necessary that all the pairs of the radiating ribs have an angle relative to the vertical direction G, as long as at least one of the first radiating ribs and the corresponding second radiating rib have an angle relative to the vertical direction G.

Furthermore, in the first embodiment, an example where two radiating ribs are provided for each of the chassis plate and the back cover has been described, however, the number of pairs of the radiating ribs to be provided for the chassis plate and the back cover may be one, three, or more, which may be provided optimally according to the specifications of display apparatuses, or the like.

### Second Embodiment

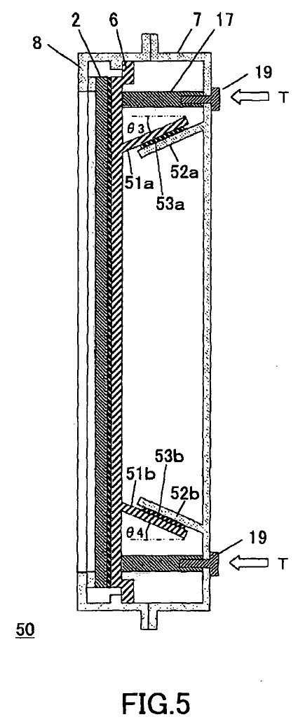

FIG. 5 is a cross sectional view illustrating a display apparatus 50 in accordance with the second embodiment of the present invention showing the detail of radiating ribs. The components that are identical to those of the display apparatus 1 in the first embodiment are indicated with the same numerals as in FIG. 1, and the descriptions thereof are not repeated.

In the display apparatus 50 of the second embodiment, as with the display apparatus 1 of the first embodiment, two first radiating ribs 51a and 51b are provided on a chassis plate 56, and two second ribs 52a and 52b are provided on a back cover 57 so as to be respectively in contact with the first radiating ribs 51a and 51b. The display apparatus 50 according to the second embodiment is different from the display apparatus 1 according to the first embodiment in that the first radiating ribs 51a and 51b, and the second radiating ribs 52a and 52b are disposed at an angle relative to the fastening direction T of the screws 19. Hereinafter, the first radiating rib or the second radiating rib also simply is referred to as “radiating rib”.

The radiating ribs 51a and 51b are provided at a position where the temperature of the chassis plate 56 locally rises like a point that is covered by circuit boards. Pairs of the radiating ribs 51a and 52a, and 51b and 52b respectively are disposed at an angle relative to the fastening direction T of the screws 19. The angles are respectively referred to as θ3 and θ4. In other words, the radiating ribs 51a and 51b, and 52a and 52b extend in an orthogonal direction with fastening direction T, with a posture at a slant angle relative to the second surface of chassis plate 56. In this regard, the extending directions of the radiating ribs 51a and 52a, and 51b and 52b are not limited specifically and may be the horizontal direction, the vertical direction or an oblique direction. Further, the radiating ribs 52a and 52b of the back cover 57 respectively are located to push the radiating ribs 51a and 51b from the inside and to be in surface contact with the radiating ribs 51a and 51b, in mounting the back cover 57.

In order to mount the back cover 57 including such radiating ribs 52a and 52b to the chassis plate 56, heat conductive sheets 53a and 53b respectively are placed on the surfaces, which are facing the back cover 57, of the radiating ribs 51a and 51b of the chassis plate 56. In this state, the back cover 57 is mounted temporarily so that the heat conductive sheets 53a and 53b are pressed by the radiating ribs 52a and 52b. After that, the back cover 57 is fixed, with the screws 19, to the bosses 17 provided on the chassis plate 56.

Such mounting allows the radiating ribs 52a and 52b to push the radiating ribs 51a and 51b mounted on the chassis plate 56, in fastening the back cover 57 onto the chassis plate 56 with the screws 19, so that the contact pressure of the respective surfaces between the radiating ribs 51a and 52a, and 51b and 52b is increased. As a result, the heat can be conducted efficiently from the chassis plate 56 to the back cover 57. As described above, also in the second embodiment of the present invention, it is possible to avoid generation of inhomogeneous distribution of the temperature in the panel 2 and to keep the temperature of the panel 2 low, while conducting the heat of the chassis plate 56 to the back cover 57, with a relatively simple structure.

As seen from the above, it is preferable that at least one of the contact surfaces between the first radiating ribs, provided on the chassis plate, and the corresponding second radiating rib, provided on the back cover, has an angle relative to the fastening direction of the screws. This structure can increase the contact pressure between the surfaces of the radiating ribs. As a result, the heat can be conducted efficiently from the chassis plate to the back cover. To implement this, the cross sectional shape of the first radiating rib and the second radiating rib may be, for example, a trapezoidal shape, instead of a rectangular shape.

Further, also in the second embodiment, vent holes may be provided in the radiating ribs 51a and 51b, and 52a and 52b, as needed. Providing the vent holes allows air to flow smoothly, thereby increasing the heat radiating efficiency.

Moreover, in the second embodiment shown in FIG. 5, although the radiating ribs 51a and 51b, and the radiating ribs 52a and 52b are provided so that the respective distances between the radiating ribs 51a and 51b, and radiating ribs 52a and 52b are widening as going to the opposite direction of the fastening direction T, it is not limited to such an arrangement. For example, not shown in figures, the first radiating ribs on the chassis plate and the second radiating ribs on the back cover may be provided so that the respective distances between the first radiating ribs and the second radiating ribs are narrowing as going to the opposite direction of the fastening direction T. The second radiating ribs may be located to push the first radiating ribs from the outside and to be in surface contact with the respective first radiating ribs, in mounting the back cover.

Furthermore, it is not necessary that all the pairs of radiating ribs have an angle relative to the fastening direction T of the screws 19, as long as at least one of the first radiating ribs and the corresponding second radiating rib have an angle relative to the fastening direction T. Moreover, the number of pairs of the first and the second radiating ribs may be one, three or more.

### Other Embodiments

In the first and the second embodiments, although an example in which a plasma display panel is used as a display device has been described, other display devices, such as a liquid crystal display device, an organic electroluminescence (EL) display device, and an inorganic EL display device, may be used as the display device of the present invention.

In addition, concrete numerical values or the like used in the first and the second embodiments are no more than an example. Therefore, it is preferable that such a value may be set optimally according to the specifications of display apparatuses, the characteristics of panels, or the like.

The present invention makes it possible to release efficiently the heat generated in use of the apparatus so as to prevent the temperature of a display device from increasing in a display apparatus using a flat image display device. Therefore, the present invention is especially useful for a plasma display apparatus using a plasma display panel.

1. A display apparatus comprising:
a display device;
a circuit board on which a circuit for driving the display device is formed;
a chassis plate having a first surface to which the display device is mounted and a second surface to which the circuit board is mounted; and
a back cover covering the second surface of the chassis plate over the circuit board,
wherein the chassis plate has a first radiating rib, and
the back cover has a second radiating rib that is in surface contact with the first radiating rib.

2. The display apparatus according to claim 1,
wherein the chassis plate has a plurality of the first radiating ribs, and
the back cover has a plurality of the second radiating ribs.

3. The display apparatus according to claim 2,
wherein at least one of the first radiating ribs and the corresponding second radiating rib are disposed at an angle relative to the vertical direction.

4. The display apparatus according to claim 2,
wherein the back cover is fastened onto the chassis plate by a screw, and
at least one of the first radiating ribs and the corresponding second radiating rib are disposed at an angle relative to the fastening direction of the screw.

5. The display apparatus according to claim 2,
wherein at least one of contact surfaces between the first radiating rib and the second radiating rib has an angle relative to the vertical direction.

6. The display apparatus according to claim 2,
wherein the back cover is fastened onto the chassis plate by a screw, and
at least one of contact surfaces between the first radiating rib and the second radiating rib has an angle relative to the fastening direction of the screw.

7. The display apparatus according to claim 2, further comprising a heat conductive sheet placed between at least one of the first radiating ribs and the corresponding second radiating rib.
